(19) United States
(12) Patent Application Publication
(10) Pub. No.: US 2015/0220831 A1
(43) Pub. Date: Aug. 6, 2015

(54) SHORT-TERM SYNAPTIC MEMORY BASED ON A PRESYNAPTIC SPIKE

(71) Applicant: QUALCOMM Incorporated, San Diego, CA (US)

(72) Inventors: Jason Frank HUNZINGER, Escondido, CA (US); Ryan CAREY, San Diego, CA (US); Victor Hokkiu CHAN, Del Mar, CA (US); Casimir Matthew WIERZYNSKI, San Diego, CA (US)

(73) Assignee: QUALCOMM Incorporated, San Diego, CA (US)

(21) Appl. No.: 14/174,685

(22) Filed: Feb. 6, 2014

(51) Int. Cl. G06N 3/08

(52) U.S. Cl. CPC G06N 3/08

(57) ABSTRACT

A method for creating and maintaining short term memory using short term plasticity, includes changing a gain of a synapse based on presynaptic spike activity without regard to postsynaptic spike activity. The method also includes calculating the gain based on a continuously updated synaptic state variable associated with the short term plasticity.

### BACKGROUND

1. Field

Certain aspects of the present disclosure generally relate to neural systems engineering and, more particularly, to systems and methods implementing a short-term synaptic memory based on a presynaptic spike.

2. Background

An artificial neural network, which may comprise an interconnected group of artificial neurons (i.e., neuron models), is a computational device or represents a method to be performed by a computational device. Artificial neural networks may have corresponding structure and/or function in biological neural networks. However, artificial neural networks may provide innovative and useful computational techniques for certain applications in which traditional computational techniques are cumbersome, impractical, or inadequate. Because artificial neural networks can infer a function from observations, such networks are particularly useful in applications where the complexity of the task or data makes the design of the function by conventional techniques burdensome. Thus, it is desirable to provide a neuromorphic receiver that includes a short-term memory.

### SUMMARY

In one aspect of the present disclosure, a method for creating and maintaining short term memory using short term plasticity is presented. The method includes changing a gain of a synapse based on presynaptic spike activity without regard to postsynaptic spike activity.

Another aspect of the present disclosure is directed to an apparatus including means for changing a gain of a synapse based on presynaptic spike activity without regard to postsynaptic spike activity.

In another aspect of the present disclosure, a computer program product for creating and maintaining short term memory using short term plasticity is disclosed. The computer program product has a non-transitory computer-readable medium. The computer readable medium has non-transitory program code recorded thereon which, when executed by the processor(s), causes the processor(s) to perform operations of changing a gain of a synapse based on presynaptic spike activity without regard to postsynaptic spike activity.

Another aspect discloses a wireless communication device having a memory and at least one processor coupled to the memory. The processor(s) is configured to change a gain of a synapse based on presynaptic spike activity without regard to postsynaptic spike activity.

In yet another aspect of the present disclosure, a method for creating and maintaining short term memory using short term plasticity is presented. The method includes storing state information in a synapse based on presynaptic activity. The method further includes retrieving the state information as postsynaptic activity.

Another aspect of the present disclosure is directed to an apparatus including means for storing state information in a synapse based on presynaptic activity. The apparatus also includes means for retrieving the state information as postsynaptic activity.

In another aspect of the present disclosure, a computer program product for creating and maintaining short term memory using short term plasticity is disclosed. The computer program product has a non-transitory computer-readable medium. The computer readable medium has non-transitory program code recorded thereon which, when executed by the processor(s), causes the processor(s) to store state information in a synapse based on presynaptic activity. The program code also causes the processor(s) to retrieve the state information as postsynaptic activity.

Another aspect discloses a wireless communication apparatus having a memory and at least one processor coupled to the memory. The processor(s) is configured to store state information in a synapse based on presynaptic activity. The processor(s) is further configured to retrieve the state information as postsynaptic activity.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example network of neurons in accordance with certain aspects of the present disclosure.

FIG. 2 illustrates an example of a processing unit (neuron) of a computational network (neural system or neural network) in accordance with certain aspects of the present disclosure.

FIG. 3 illustrates an example of spike-timing dependent plasticity (STDP) curve in accordance with certain aspects of the present disclosure.

FIG. 4 illustrates an example of a positive regime and a negative regime for defining behavior of a neuron model in accordance with certain aspects of the present disclosure.

FIG. 5A illustrates an example of a neuron model based on an aspect of the present disclosure.

FIGS. 5B and 5C illustrate examples of a spiking voltage with and without an altered state of a synapse, according to aspects of the present disclosure.

FIG. 6 illustrates an example of spiking voltage and voltage decay based on an aspect of the present disclosure.

FIG. 7 illustrates an example implementation of designing a neural network using a general-purpose processor in accordance with certain aspects of the present disclosure.

FIG. 8 illustrates an example implementation of designing a neural network where a memory may be interfaced with individual distributed processing units in accordance with certain aspects of the present disclosure.

FIG. 9 illustrates an example implementation of designing a neural network based on distributed memories and distributed processing units in accordance with certain aspects of the present disclosure.

FIG. 10 illustrates an example implementation of a neural network in accordance with certain aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### An Example Neural System, Training and Operation

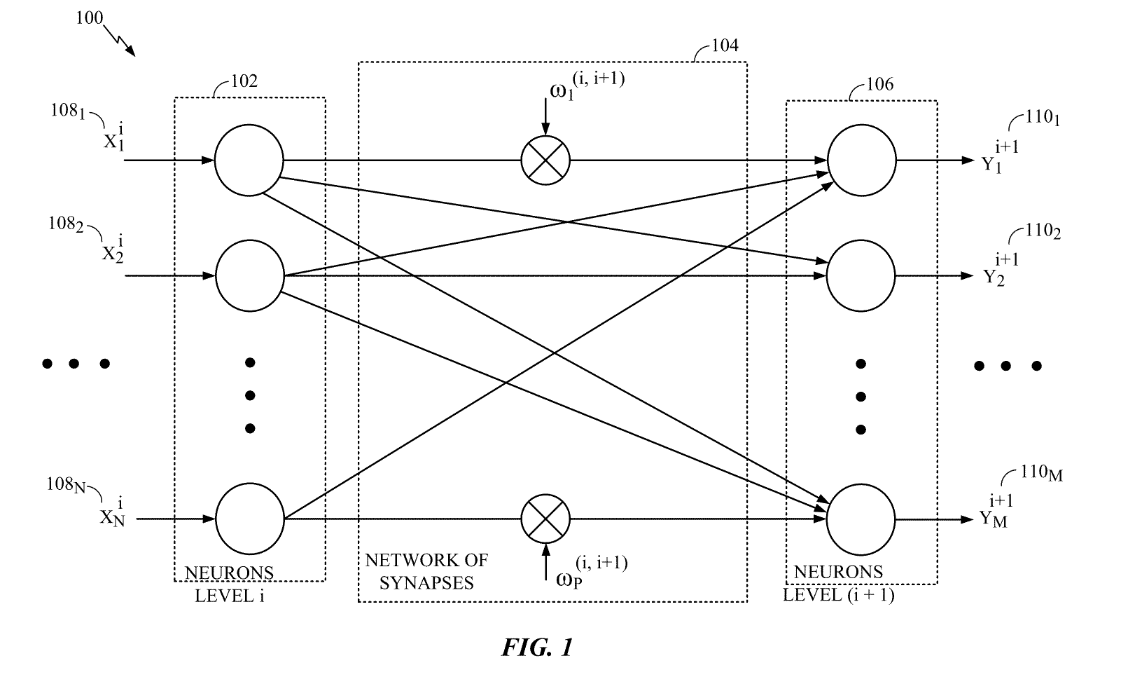

FIG. 1 illustrates an example artificial neural system 100 with multiple levels of neurons in accordance with certain aspects of the present disclosure. The neural system 100 may have a level of neurons 102 connected to another level of neurons 106 through a network of synaptic connections 104 (i.e., feed-forward connections). For simplicity, only two levels of neurons are illustrated in FIG. 1, although fewer or more levels of neurons may exist in a neural system. It should be noted that some of the neurons may connect to other neurons of the same layer through lateral connections. Furthermore, some of the neurons may connect back to a neuron of a previous layer through feedback connections.

As illustrated in FIG. 1, each neuron in the level 102 may receive an input signal 108 that may be generated by neurons of a previous level (not shown in FIG. 1). The signal 108 may represent an input current of the level 102 neuron. This current may be accumulated on the neuron membrane to charge a membrane potential. When the membrane potential reaches its threshold value, the neuron may fire and generate an output spike to be transferred to the next level of neurons (e.g., the level 106). In some modeling approaches, the neuron may continuously transfer a signal to the next level of neurons. This signal is typically a function of the membrane potential. Such behavior can be emulated or simulated in hardware and/or software, including analog and digital implementations such as those described below.

In biological neurons, the output spike generated when a neuron fires is referred to as an action potential. This electrical signal is a relatively rapid, transient, nerve impulse, having an amplitude of roughly 100 mV and a duration of about 1 ms. In a particular embodiment of a neural system having a series of connected neurons (e.g., the transfer of spikes from one level of neurons to another in FIG. 1), every action potential has basically the same amplitude and duration, and thus, the information in the signal may be represented only by the frequency and number of spikes, or the time of spikes, rather than by the amplitude. The information carried by an action potential may be determined by the spike, the neuron that spiked, and the time of the spike relative to other spike or spikes. The importance of the spike may be determined by a weight applied to a connection between neurons, as explained below.

The transfer of spikes from one level of neurons to another may be achieved through the network of synaptic connections (or simply “synapses”) 104, as illustrated in FIG. 1. Relative to the synapses 104, neurons of level 102 may be considered presynaptic neurons and neurons of level 106 may be considered postsynaptic neurons. The synapses 104 may receive output signals (i.e., spikes) from the level 102 neurons and scale those signals according to adjustable synaptic weights w₁^{(i,i+1)}, . . . , w_{P}^{(i,i+1)} where P is a total number of synaptic connections between the neurons of levels 102 and 106 and i is an indicator of the neuron level. In the example of FIG. 1, i represents neuron level 102 and i+1 represents neuron level 106. Further, the scaled signals may be combined as an input signal of each neuron in the level 106. Every neuron in the level 106 may generate output spikes 110 based on the corresponding combined input signal. The output spikes 110 may be transferred to another level of neurons using another network of synaptic connections (not shown in FIG. 1).

Biological synapses can mediate either excitatory or inhibitory (hyperpolarizing) actions in postsynaptic neurons and can also serve to amplify neuronal signals. Excitatory signals depolarize the membrane potential (i.e., increase the membrane potential with respect to the resting potential). If enough excitatory signals are received within a certain time period to depolarize the membrane potential above a threshold, an action potential occurs in the postsynaptic neuron. In contrast, inhibitory signals generally hyperpolarize (i.e., lower) the membrane potential. Inhibitory signals, if strong enough, can counteract the sum of excitatory signals and prevent the membrane potential from reaching a threshold. In addition to counteracting synaptic excitation, synaptic inhibition can exert powerful control over spontaneously active neurons. A spontaneously active neuron refers to a neuron that spikes without further input, for example due to its dynamics or a feedback. By suppressing the spontaneous generation of action potentials in these neurons, synaptic inhibition can shape the pattern of firing in a neuron, which is generally referred to as sculpturing. The various synapses 104 may act as any combination of excitatory or inhibitory synapses, depending on the behavior desired.

The neural system 100 may be emulated by a general purpose processor, a digital signal processor (DSP), an application specific integrated circuit (ASIC), a field programmable gate array (FPGA) or other programmable logic device (PLD), discrete gate or transistor logic, discrete hardware components, a software module executed by a processor, or any combination thereof. The neural system 100 may be utilized in a large range of applications, such as image and pattern recognition, machine learning, motor control, and alike. Each neuron in the neural system 100 may be implemented as a neuron circuit. The neuron membrane charged to the threshold value initiating the output spike may be implemented, for example, as a capacitor that integrates an electrical current flowing through it.

In an aspect, the capacitor may be eliminated as the electrical current integrating device of the neuron circuit, and a smaller memristor element may be used in its place. This approach may be applied in neuron circuits, as well as in various other applications where bulky capacitors are utilized as electrical current integrators. In addition, each of the synapses 104 may be implemented based on a memristor element, where synaptic weight changes may relate to changes of the memristor resistance. With nanometer feature-sized memristors, the area of a neuron circuit and synapses may be substantially reduced, which may make implementation of a large-scale neural system hardware implementation more practical.

Functionality of a neural processor that emulates the neural system 100 may depend on weights of synaptic connections, which may control strengths of connections between neurons. The synaptic weights may be stored in a non-volatile memory in order to preserve functionality of the processor after being powered down. In an aspect, the synaptic weight memory may be implemented on a separate external chip from the main neural processor chip. The synaptic weight memory may be packaged separately from the neural processor chip as a replaceable memory card. This may provide diverse functionalities to the neural processor, where a particular functionality may be based on synaptic weights stored in a memory card currently attached to the neural processor.

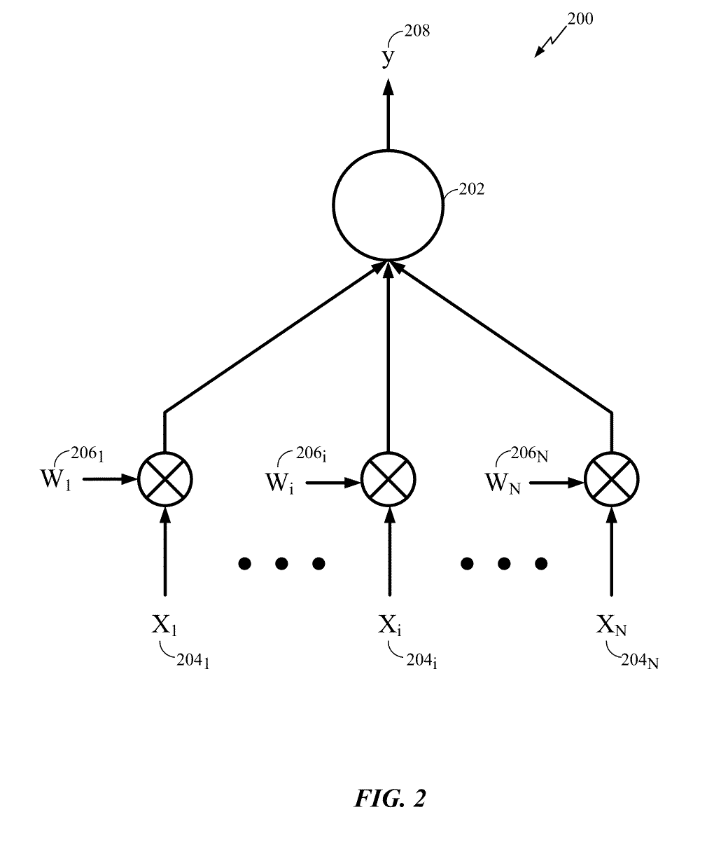

FIG. 2 illustrates an exemplary diagram 200 of a processing unit (e.g., a neuron or neuron circuit) 202 of a computational network (e.g., a neural system or a neural network) in accordance with certain aspects of the present disclosure. For example, the neuron 202 may correspond to any of the neurons of levels 102 and 106 from FIG. 1. The neuron 202 may receive multiple input signals 204₁-204_{N}, which may be signals external to the neural system, or signals generated by other neurons of the same neural system, or both. The input signal may be a current, a conductance, a voltage, a real-valued, and/or a complex-valued. The input signal may comprise a numerical value with a fixed-point or a floating-point representation. These input signals may be delivered to the neuron 202 through synaptic connections that scale the signals according to adjustable synaptic weights 206₁-206_{N} (W₁-W_{N}), where N may be a total number of input connections of the neuron 202.

The neuron 202 may combine the scaled input signals and use the combined scaled inputs to generate an output signal 208 (i.e., a signal Y). The output signal 208 may be a current, a conductance, a voltage, a real-valued and/or a complex-valued. The output signal may be a numerical value with a fixed-point or a floating-point representation. The output signal 208 may be then transferred as an input signal to other neurons of the same neural system, or as an input signal to the same neuron 202, or as an output of the neural system.

The processing unit (neuron) 202 may be emulated by an electrical circuit, and its input and output connections may be emulated by electrical connections with synaptic circuits. The processing unit 202 and its input and output connections may also be emulated by a software code. The processing unit 202 may also be emulated by an electric circuit, whereas its input and output connections may be emulated by a software code. In an aspect, the processing unit 202 in the computational network may be an analog electrical circuit. In another aspect, the processing unit 202 may be a digital electrical circuit. In yet another aspect, the processing unit 202 may be a mixed-signal electrical circuit with both analog and digital components. The computational network may include processing units in any of the aforementioned forms. The computational network (neural system or neural network) using such processing units may be utilized in a large range of applications, such as image and pattern recognition, machine learning, motor control, and the like.

During the course of training a neural network, synaptic weights (e.g., the weights w₁^{(i,i+1)}, . . . , w_{P}^{(i,i+1)} from FIG. 1 and/or the weights 206₁-206_{N} from FIG. 2) may be initialized with random values and increased or decreased according to a learning rule. Those skilled in the art will appreciate that examples of the learning rule include, but are not limited to the spike-timing-dependent plasticity (STDP) learning rule, the Hebb rule, the Oja rule, the Bienenstock-Copper-Munro (BCM) rule, etc. In certain aspects, the weights may settle or converge to one of two values (i.e., a bimodal distribution of weights). This effect can be utilized to reduce the number of bits for each synaptic weight, increase the speed of reading and writing from/to a memory storing the synaptic weights, and to reduce power and/or processor consumption of the synaptic memory.

### Synapse Type

In hardware and software models of neural networks, the processing of synapse related functions can be based on synaptic type. Synapse types may be non-plastic synapses (no changes of weight and delay), plastic synapses (weight may change), structural delay plastic synapses (weight and delay may change), fully plastic synapses (weight, delay and connectivity may change), and variations thereupon (e.g., delay may change, but no change in weight or connectivity). The advantage of multiple types is that processing can be subdivided. For example, non-plastic synapses may not require plasticity functions to be executed (or waiting for such functions to complete). Similarly, delay and weight plasticity may be subdivided into operations that may operate together or separately, in sequence or in parallel. Different types of synapses may have different lookup tables or formulas and parameters for each of the different plasticity types that apply. Thus, the methods would access the relevant tables, formulas, or parameters for the synapse's type.

There are further implications of the fact that spike-timing dependent structural plasticity may be executed independently of synaptic plasticity. Structural plasticity may be executed even if there is no change to weight magnitude (e.g., if the weight has reached a minimum or maximum value, or it is not changed due to some other reason) s structural plasticity (i.e., an amount of delay change) may be a direct function of pre-post spike time difference. Alternatively, structural plasticity may be set as a function of the weight change amount or based on conditions relating to bounds of the weights or weight changes. For example, a synapse delay may change only when a weight change occurs or if weights reach zero but not if they are at a maximum value. However, it may be advantageous to have independent functions so that these processes can be parallelized reducing the number and overlap of memory accesses.

### Determination of Synaptic Plasticity

Neuroplasticity (or simply “plasticity”) is the capacity of neurons and neural networks in the brain to change their synaptic connections and behavior in response to new information, sensory stimulation, development, damage, or dysfunction. Plasticity is important to learning and memory in biology, as well as for computational neuroscience and neural networks. Various forms of plasticity have been studied, such as synaptic plasticity (e.g., according to the Hebbian theory), spike-timing-dependent plasticity (STDP), non-synaptic plasticity, activity-dependent plasticity, structural plasticity and homeostatic plasticity.

STDP is a learning process that adjusts the strength of synaptic connections between neurons. The connection strengths are adjusted based on the relative timing of a particular neuron's output and received input spikes (i.e., action potentials). Under the STDP process, long-term potentiation (LTP) may occur if an input spike to a certain neuron tends, on average, to occur immediately before that neuron's output spike. Then, that particular input is made somewhat stronger. On the other hand, long-term depression (LTD) may occur if an input spike tends, on average, to occur immediately after an output spike. Then, that particular input is made somewhat weaker, and hence the name “spike-timing-dependent plasticity.” Consequently, inputs that might be the cause of the postsynaptic neuron's excitation are made even more likely to contribute in the future, whereas inputs that are not the cause of the postsynaptic spike are made less likely to contribute in the future. The process continues until a subset of the initial set of connections remains, while the influence of all others is reduced to an insignificant level.

Because a neuron generally produces an output spike when many of its inputs occur within a brief period (i.e., being cumulative sufficient to cause the output), the subset of inputs that typically remains includes those that tended to be correlated in time. In addition, because the inputs that occur before the output spike are strengthened, the inputs that provide the earliest sufficiently cumulative indication of correlation will eventually become the final input to the neuron.

The STDP learning rule may effectively adapt a synaptic weight of a synapse connecting a presynaptic neuron to a postsynaptic neuron as a function of time difference between spike time tₚᵣₑ of the presynaptic neuron and spike time tₚₒₛₜ of the postsynaptic neuron (i.e., t=tₚₒₛₜ−tₚᵣₑ). A typical formulation of the STDP is to increase the synaptic weight (i.e., potentiate the synapse) if the time difference is positive (the presynaptic neuron fires before the postsynaptic neuron), and decrease the synaptic weight (i.e., depress the synapse) if the time difference is negative (the postsynaptic neuron fires before the presynaptic neuron).

In the STDP process, a change of the synaptic weight over time may be typically achieved using an exponential decay, as given by:

$$Δ w ( t ) = \{ \begin{matrix}{a}_{+} {e}^{- t / {k}_{+}} + μ , & t > 0 \\ {a}_{\_} {e}^{t / k -} , & t < 0 ,\end{matrix} \qquad ( 1 )$$

where k₊ and k₋τ_{sign(Δt)} are time constants for positive and negative time difference, respectively, a₊ and a₋ are corresponding scaling magnitudes, and μ is an offset that may be applied to the positive time difference and/or the negative time difference.

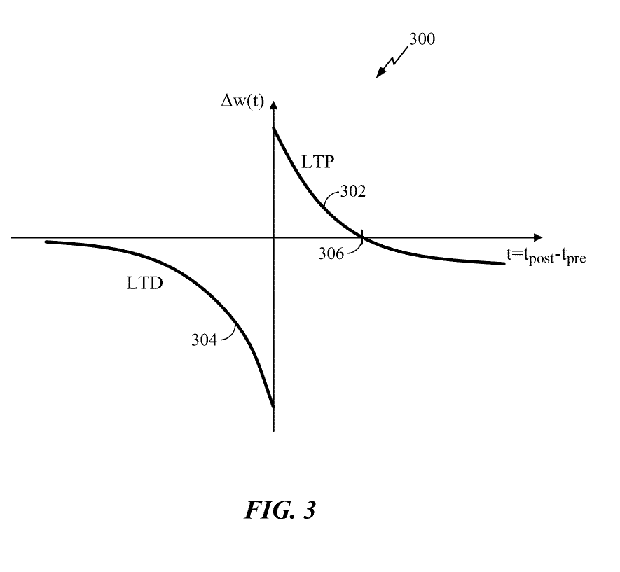

FIG. 3 illustrates an exemplary diagram 300 of a synaptic weight change as a function of relative timing of presynaptic and postsynaptic spikes in accordance with the STDP. If a presynaptic neuron fires before a postsynaptic neuron, then a corresponding synaptic weight may be increased, as illustrated in a portion 302 of the graph 300. This weight increase can be referred to as an LTP of the synapse. It can be observed from the graph portion 302 that the amount of LTP may decrease roughly exponentially as a function of the difference between presynaptic and postsynaptic spike times. The reverse order of firing may reduce the synaptic weight, as illustrated in a portion 304 of the graph 300, causing an LTD of the synapse.

As illustrated in the graph 300 in FIG. 3, a negative offset μ may be applied to the LTP (causal) portion 302 of the STDP graph. A point of cross-over 306 of the x-axis (y=0) may be configured to coincide with the maximum time lag for considering correlation for causal inputs from layer i−1. In the case of a frame-based input (i.e., an input that is in the form of a frame of a particular duration comprising spikes or pulses), the offset value μ can be computed to reflect the frame boundary. A first input spike (pulse) in the frame may be considered to decay over time either as modeled by a postsynaptic potential directly or in terms of the effect on neural state. If a second input spike (pulse) in the frame is considered correlated or relevant to a particular time frame, then the relevant times before and after the frame may be separated at that time frame boundary and treated differently in plasticity terms by offsetting one or more parts of the STDP curve such that the value in the relevant times may be different (e.g., negative for greater than one frame and positive for less than one frame). For example, the negative offset μ may be set to offset LTP such that the curve actually goes below zero at a pre-post time greater than the frame time and it is thus part of LTD instead of LTP.

### Neuron Models and Operation

There are some general principles for designing a useful spiking neuron model. A good neuron model may have rich potential behavior in terms of two computational regimes: coincidence detection and functional computation. Moreover, a good neuron model should have two elements to allow temporal coding: arrival time of inputs affects output time and coincidence detection can have a narrow time window. Finally, to be computationally attractive, a good neuron model may have a closed-form solution in continuous time and stable behavior including near attractors and saddle points. In other words, a useful neuron model is one that is practical and that can be used to model rich, realistic and biologically-consistent behaviors, as well as be used to both engineer and reverse engineer neural circuits.

A neuron model may depend on events, such as an input arrival, output spike or other event whether internal or external. To achieve a rich behavioral repertoire, a state machine that can exhibit complex behaviors may be desired. If the occurrence of an event itself, separate from the input contribution (if any), can influence the state machine and constrain dynamics subsequent to the event, then the future state of the system is not only a function of a state and input, but rather a function of a state, event, and input.

In an aspect, a neuron n may be modeled as a spiking leaky-integrate-and-fire neuron with a membrane voltage vₙ(t) governed by the following dynamics:

$$\frac{d {v}_{n} ( t )}{d t} = α {v}_{n} ( t ) + β {\sum }_{m} {w}_{m , n} {y}_{m} ( t - Δ {t}_{m , n} ) , \qquad ( 2 )$$

where α and β are parameters, w_{m,n} is a synaptic weight for the synapse connecting a presynaptic neuron m to a postsynaptic neuron n, and yₘ(t) is the spiking output of the neuron m that may be delayed by dendritic or axonal delay according to Δt_{m,n} until arrival at the neuron n's soma.

It should be noted that there is a delay from the time when sufficient input to a postsynaptic neuron is established until the time when the postsynaptic neuron actually fires. In a dynamic spiking neuron model, such as Izhikevich's simple model, a time delay may be incurred if there is a difference between a depolarization threshold vₜ and a peak spike voltage vₚₑₐₖ. For example, in the simple model, neuron soma dynamics can be governed by the pair of differential equations for voltage and recovery, i.e.:

$$\begin{matrix}\frac{d v}{d t} = ( k ( v - {v}_{t} ) ( v - {v}_{r} ) - u + I ) / C , & ( 3 ) \\ \frac{d u}{d t} = a ( b ( v - {v}_{r} ) - u ) . & ( 4 )\end{matrix}$$

where v is a membrane potential, u is a membrane recovery variable, k is a parameter that describes time scale of the membrane potential v, a is a parameter that describes time scale of the recovery variable u, b is a parameter that describes sensitivity of the recovery variable u to the sub-threshold fluctuations of the membrane potential v, vᵣ is a membrane resting potential, I is a synaptic current, and C is a membrane's capacitance. In accordance with this model, the neuron is defined to spike when v>vₚₑₐₖ.

### Hunzinger Cold Model

The Hunzinger Cold neuron model is a minimal dual-regime spiking linear dynamical model that can reproduce a rich variety of neural behaviors. The model's one- or two-dimensional linear dynamics can have two regimes, wherein the time constant (and coupling) can depend on the regime. In the sub-threshold regime, the time constant, negative by convention, represents leaky channel dynamics generally acting to return a cell to rest in a biologically-consistent linear fashion. The time constant in the supra-threshold regime, positive by convention, reflects anti-leaky channel dynamics generally driving a cell to spike while incurring latency in spike-generation.

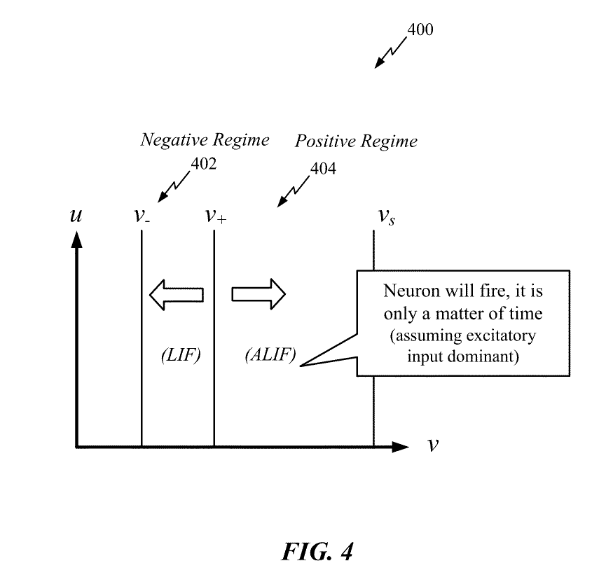

As illustrated in FIG. 4, the dynamics of the model 400 may be divided into two (or more) regimes. These regimes may be called the negative regime 402 (also interchangeably referred to as the leaky-integrate-and-fire (LIF) regime, not to be confused with the LIF neuron model) and the positive regime 404 (also interchangeably referred to as the anti-leaky-integrate-and-fire (ALIF) regime, not to be confused with the ALIF neuron model). In the negative regime 402, the state tends toward rest (v₋) at the time of a future event. In this negative regime, the model generally exhibits temporal input detection properties and other sub-threshold behavior. In the positive regime 404, the state tends toward a spiking event (vₛ). In this positive regime, the model exhibits computational properties, such as incurring a latency to spike depending on subsequent input events. Formulation of dynamics in terms of events and separation of the dynamics into these two regimes are fundamental characteristics of the model.

Linear dual-regime bi-dimensional dynamics (for states v and u) may be defined by convention as:

$$\begin{matrix}{τ}_{ρ} \frac{d v}{d t} = v + {q}_{ρ} & ( 5 ) \\ - {τ}_{u} \frac{d u}{d t} = u + r & ( 6 )\end{matrix}$$

where q_{ρ} and r are the linear transformation variables for coupling.

The symbol ρ is used herein to denote the dynamics regime with the convention to replace the symbol ρ with the sign “−” or “+” for the negative and positive regimes, respectively, when discussing or expressing a relation for a specific regime.

The model state is defined by a membrane potential (voltage) v and recovery current u. In basic form, the regime is essentially determined by the model state. There are subtle, but important aspects of the precise and general definition, but for the moment, consider the model to be in the positive regime 404 if the voltage v is above a threshold (v₊) and otherwise in the negative regime 402.

The regime-dependent time constants include τ₋ which is the negative regime time constant, and τ₊ which is the positive regime time constant. The recovery current time constant τᵤ is typically independent of regime. For convenience, the negative regime time constant τ₋ is typically specified as a negative quantity to reflect decay so that the same expression for voltage evolution may be used as for the positive regime in which the exponent and τ₊ will generally be positive, as will be τᵤ.

The dynamics of the two state elements may be coupled at events by transformations offsetting the states from their null-clines, where the transformation variables are:

q_{ρ}=−τ_{ρ}βu−v_{ρ} (7)

r=δ(v+ε) (8)

where δ, ε, β and v₋, v₊ are parameters. The two values for v_{ρ} are the base for reference voltages for the two regimes. The parameter v₋ is the base voltage for the negative regime, and the membrane potential will generally decay toward v₋ in the negative regime. The parameter v₊ is the base voltage for the positive regime, and the membrane potential will generally tend away from v₊ in the positive regime.

The null-clines for v and u are given by the negative of the transformation variables q_{ρ} and r, respectively. The parameter δ is a scale factor controlling the slope of the u null-cline. The parameter ε is typically set equal to −v₋. The parameter β is a resistance value controlling the slope of the v null-clines in both regimes. The τ_{ρ} time-constant parameters control not only the exponential decays, but also the null-cline slopes in each regime separately.

The model may be defined to spike when the voltage v reaches a value v_{S}. Subsequently, the state may be reset at a reset event (which may be one and the same as the spike event):

v=\hat{v}₋ (9)

u=u+Δu (10)

where \hat{v}₋ and Δu are parameters. The reset voltage \hat{v}₋ is typically set to v₋.

By a principle of momentary coupling, a closed form solution is possible not only for state (and with a single exponential term), but also for the time required to reach a particular state. The close form state solutions are:

$$\begin{matrix}v ( t + Δ t ) = ( v ( t ) + {q}_{ρ} ) {e}^{\frac{Δ t}{{τ}_{ρ}}} - {q}_{ρ} & ( 11 ) \\ u ( t + Δ t ) = ( u ( t ) + r ) {e}^{- \frac{Δ t}{{τ}_{u}}} - r & ( 12 )\end{matrix}$$

Therefore, the model state may be updated only upon events, such as an input (presynaptic spike) or output (postsynaptic spike). Operations may also be performed at any particular time (whether or not there is input or output).

Moreover, by the momentary coupling principle, the time of a postsynaptic spike may be anticipated so the time to reach a particular state may be determined in advance without iterative techniques or Numerical Methods (e.g., the Euler numerical method). Given a prior voltage state v₀, the time delay until voltage state v_{f} is reached is given by:

$$Δ t = {τ}_{ρ} log \frac{{v}_{f} + {q}_{ρ}}{{v}_{0} + {q}_{ρ}} \qquad ( 13 )$$

If a spike is defined as occurring at the time the voltage state v reaches v_{S}, then the closed-form solution for the amount of time, or relative delay, until a spike occurs as measured from the time that the voltage is at a given state v is:

$$Δ {t}_{S} = \{ \begin{matrix}{τ}_{+} log \frac{{v}_{S} + {q}_{+}}{v + {q}_{+}} & if v > {\hat{v}}_{+} \\ ∞ & otherwise\end{matrix} \qquad ( 14 )$$

where \hat{v}₊ is typically set to parameter v₊, although other variations may be possible.

The above definitions of the model dynamics depend on whether the model is in the positive or negative regime. As mentioned, the coupling and the regime p may be computed upon events. For purposes of state propagation, the regime and coupling (transformation) variables may be defined based on the state at the time of the last (prior) event. For purposes of subsequently anticipating spike output time, the regime and coupling variable may be defined based on the state at the time of the next (current) event.

There are several possible implementations of the Cold model, and executing the simulation, emulation or model in time. This includes, for example, event-update, step-event update, and step-update modes. An event update is an update where states are updated based on events or “event update” (at particular moments). A step update is an update when the model is updated at intervals (e.g., 1 ms). This does not necessarily require iterative methods or Numerical methods. An event-based implementation is also possible at a limited time resolution in a step-based simulator by only updating the model if an event occurs at or between steps or by “step-event” update.

Spike Timing Memory with Short-Term Plasticity

Aspects of the present disclosure are directed to a memory, such as a short-term memory, specified for a neural network. The memory may be written to, read from, maintained, or erased. In the present application, the term neural network may be referred to as a network.

In one configuration, a memory is created by controlling the gain associated with a synapse. In this configuration the memory may be changed by short-term plasticity.

Specifically, in one configuration, a short-term change, such as an increase or a decrease, of a synapse's strength (i.e., gain) may be based on a presynaptic activity. The presynaptic activity can include timing of a presynaptic spike and/or the timing of a set of presynaptic spikes. In one configuration, the gain is a function of the timing of the presynaptic activity. In the present application, the term short-term synaptic gain function may refer to the function of the presynaptic spike timing. The gain may be a function of the time since the most recent presynaptic spike. The function may be in the form of an exponential decay. The function may be a non-linear function of an exponential decay, to provide a minimum threshold for synaptic transmission.

The function allows the gain to increase and/or decrease. Increased gain may be referred to as facilitation. Decreased gain may be referred to as depression.

Because the gain is subject to decay, the memory may be maintained by applying periodic presynaptic spikes, such as maintenance signals. In one configuration, the short term plasticity can be implemented using a continuously-updated synaptic state variable, from which the current gain can be calculated. In another configuration, the synaptic gain is calculated only when desired for a post-synaptic transmission. In another configuration, this short-term plasticity is implemented using a state variable in the pre-synaptic neuron model, instead of within the synapse model. Short-term plasticity may regulate various synapse types.

In some cases, short-term plasticity may be used for short-term memory. State information may be stored, maintained, updated, and erased in a synapse using presynaptic activity. In some cases, the presynaptic activity may be referred to as persistent periodic presynaptic spiking. State information may be retrieved as post-synaptic activity. In one configuration, the number of possible states is two. In another configuration, the number of possible states is greater than two (i.e., multistate).

Because the gain is typically subject to decay, if a longer persistence is desired beyond the decay time, the memory may be maintained by applying periodic presynaptic spikes, which may be referred to as maintenance spikes. Persistent presynaptic spiking with a regular period may provide a signal to indicate that the state value should be maintained. In one configuration, the system tolerates a certain amount of jitter in maintenance spike timing such that it may not be exactly periodic.

Additional pre-synaptic spikes (beyond the frequency of the maintenance spikes) within a certain window indicate that the state value should be increased. The magnitude of increase can be a function of the number of additional pre-synaptic spikes. Missed pre-synaptic maintenance spikes (below the frequency of the maintenance spikes) within a certain window indicate that the state value should be decreased. The magnitude of decrease can be a function of the number of missed maintenance spikes.

The gain of the post-synaptic transmission carries information about the current state value. The current state value can be equal to the transmitted gain. The current state value can be a function of the transmitted gain. The synapse implements the short-term plasticity mechanism described above where the maintenance spike period is determined by the exponential decay time constant of the short-term synaptic gain function.

In some neural networks, it may be desirable to implement short-term learning procedures to learn and/or execute a task with an increased response to an error. That is, for a specific period of time, which may be a short-term period, the user may desire for the network to perform differently than a typical operation. The short-term learning procedure may specify a memory, such as a short-term memory. In one configuration, the short-term memory may be consolidated to long-term memory such that the gain change is permanent.

Short-term memory may refer to an indefinite-term memory. In some cases, repetition and/or rehearsal are not specified in the short-term memory. That is, the short-term memory may be a single instance memory. More specifically, the short-term memory may be specified to store and/or update a state value in a synapse based on a presynaptic spike and retrieve the state value via a postsynaptic spike. The short-term memory may be versatile to read, write, erase, and/or maintain.

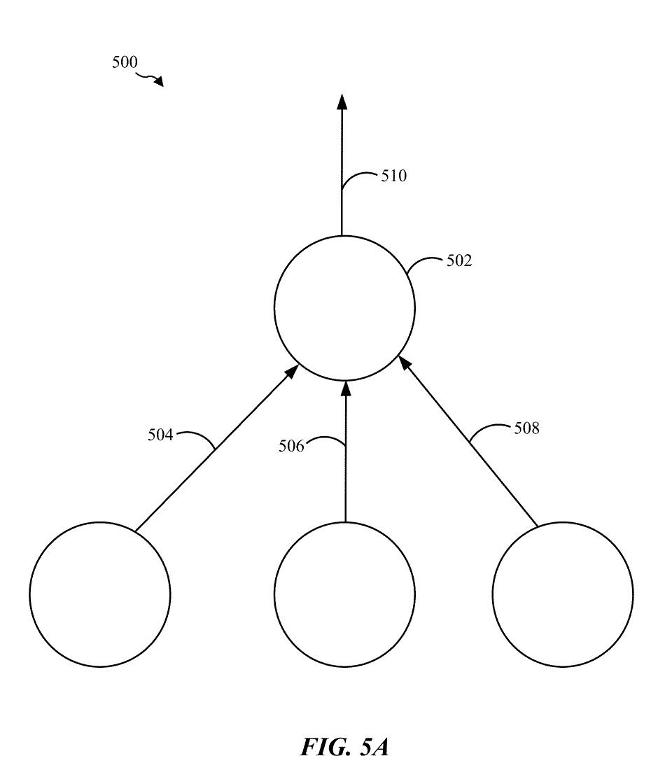

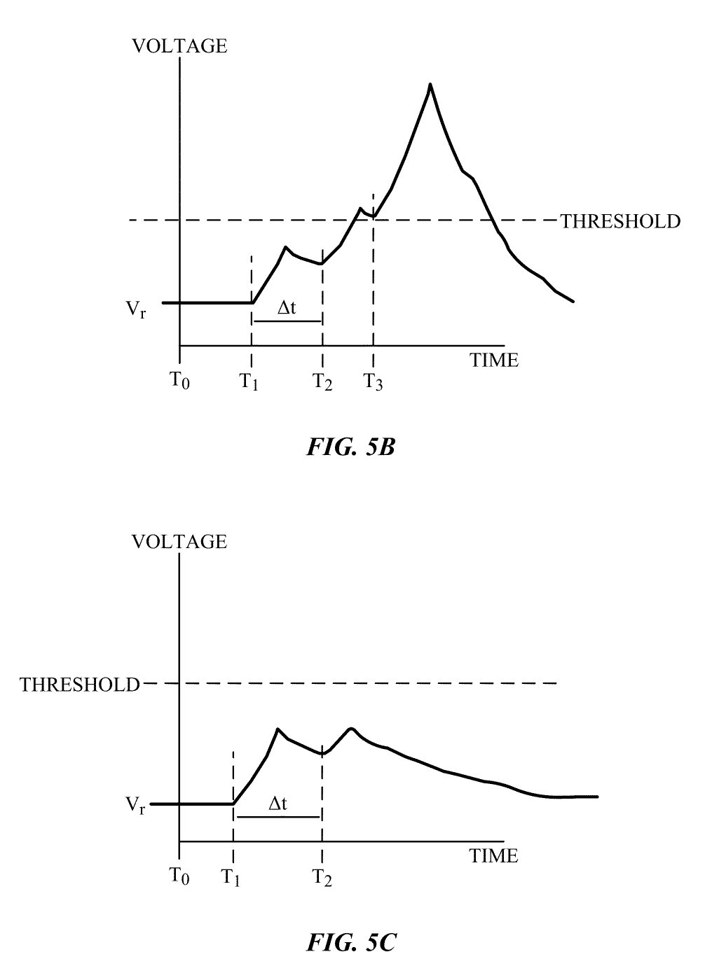

FIG. 5A illustrates a neuron 502 of a neural network 500. As shown in FIG. 5, the neuron 502 has three input synapses 504-508 and one output synapse 510. In the present example, the neuron 502 may trigger a spiking output in response to a coincidental detection of two or more inputs from synapses. That is, in a coincidental detection the neuron may spike in response to receiving a first input from a first synapse and a second input from a second synapse that is different from the first synapse.

As an example, the voltage (vᵣ) of the neuron 502 may be at rest (e.g., baseline) prior to receiving a first input from one of the three input synapses 504-508. In response to receiving the first input, the voltage of the neuron 502 may spike. Within a specific time period (ΔT) of receiving the first input, the neuron 502 may receive a second input from one of the three input synapses 504-508. In response to receiving the second input within the time period, the voltage of the neuron 502 may spike so that the voltage is greater than a threshold. That is, the combined spikes cause the voltage to exceed the threshold. The neuron 502 may transmit an output (e.g., fire) via the output synapse 510 when the voltage is greater than a threshold.

FIG. 5B illustrates an example of a neuron firing when two or more spikes, received within a specific time period, cause the voltage of the neuron to increase to a level that is greater than a threshold. As shown in FIG. 5B, at time T0, the voltage (Vr) of the neuron may be at a rest voltage. Furthermore, at time T1 the neuron may receive a first input that causes the voltage to spike to a first voltage level. The first input may be received via one of the synapses connected to the neuron. Moreover, at time T2, the neuron may receive a second input that causes the voltage to spike to a second voltage level. Specifically, the voltage spikes to the second voltage level when the second input is received within a specific time period (ΔT) of the first input. The second input may be received via one of the synapses connected to the neuron. In this example, because the second voltage level is greater than the threshold, at time T3, the voltage spikes to a third voltage level. That is, the voltage spikes (i.e., the neuron fires) to the third level when the voltage is greater than the threshold before beginning to decay.

Still, in some cases, the neuron 502 may receive consecutive inputs from the same input synapse. For example, the neuron 502 may receive a first input via the first synapse 504 and second input via the first synapse 504. In this example, the first input and second input are received within a specific time period of each other. Moreover, in the present example, in response to receiving the first input and the second input within the specific time period, the voltage of the neuron 502 may spike to a value that is greater than a threshold. Accordingly, the neuron 502 may fire via the output synapse 510 when the voltage is greater than the threshold. Nonetheless, in the present example, the spiking of the neuron 502 may be undesirable because the neuron 502 fires in response to detecting consecutive inputs from the same synapse rather than firing in response to detecting coincidental inputs from different synapses.

Thus, to mitigate a neuron firing in response to consecutive inputs from the same synapse, aspects of the present disclosure are directed to altering a state of a synapse after the synapse has fired. In one configuration, the state of the synapse is altered for a specific amount of time, such as a duration of the detection window (e.g., ΔT). As an example, based on the present configuration, the neuron 502 may receive a first input via the first synapse 504 and second input via the first synapse 504. Still, in this example, a state of the first synapse 504 may be altered after the first input so that the neuron 502 does not fire after receiving the second input via the first synapse 504.

FIG. 5C illustrates an example of altering the state of a synapse after an input has been received from the synapse. As shown in FIG. 5C, at time T0, the voltage (Vr) of the neuron may be at a rest voltage. Furthermore, at time T1 a first synapse connected to the neuron may spike so that neuron receives a first input that causes the voltage to spike to a first voltage level. In one configuration, the state of the first synapse is altered after the neuron receives the first input from the first synapse.

That is, in one configuration, the state of the synapse is altered to depress the gain of the synapse for subsequent spikes that are within a specific time period (ΔT) after the first spike (e.g., first input). In the present example, the first synapse may spike again at time T2 so that the neuron receives a second input. Still, in the present example, although the voltage of the neuron is increased to a second voltage level as a result of the second input, because the gain of the synapse has been depressed, the voltage of the neuron does not increase to a level that is greater than the threshold. That is, because of the depression, the second input received within a specific time period (ΔT) does not cause the second voltage to increase to a level that is greater than the threshold. Accordingly, in this example, the neuron does not fire because the voltage of the neuron is less than the threshold.

In one configuration, the altered state is a depression of the firing of the synapses so that a consecutive input does not increase the voltage of a neuron beyond a threshold. Therefore, according to the present configuration, the neuron still fires in response to coincidental inputs from different synapses and does not fire in response to consecutive inputs from the same synapse. In another configuration, the neuron state is altered so that the neuron does not fire or has a delay in firing when two or more consecutive inputs are received via the same synapse.

In one configuration, each synapse includes an additional state to allow the synapse to be altered for a specific time period after firing. The additional state may allow synapses to be depressed (e.g., less likely to fire) or facilitated (e.g., more likely to fire). According to an aspect of the present disclosure, a facilitation model is specified to strengthen, for a short-term, a synapse in response to a presynaptic activation. That is, state change may be a form of short-term memory that adjusts a state of a synapse based on a presynaptic condition. In the present configuration, a decay is specified for an adjusted synapse so that the state change is short-term. In one configuration, the facilitation or delay decays exponentially with multiple time constants.

The additional state for the synapse may be defined as:

$$\frac{d y}{d t} = \frac{\hat{y} - y}{{τ}_{+}^{ST}} + g ( y ) {\sum }_{j} δ ( t - {t}_{j} ) \qquad ( 15 )$$

In equation 15, δ is delta function for activation (e.g., action potentials) at time tⱼ. Furthermore, g(y) is a generalized offset function on activation. Finally, the rest period (e.g., base line) is ŷ. Equation 15 is specified to determine an input received from a synapse and to trigger an activation function y to be decayed over a period of time to a base line ŷ. It should be noted that the facilitation or depression of the synapses is not specified for post-synaptic association, rather the facilitation or depression is specified for a presynaptic association (e.g., input driven). Furthermore, τ₊^{ST} is a time constant associated with exponential decay of y back to the baseline value ŷ.

In some cases, calcium concentration may impact facilitation. That is, when a first input is followed by a second input, the second input may receive a facilitation reading that is greater than the facilitation reading of the first input. The super-linear impact of presynaptic Ca2+ on facilitation may be defined by:

y˜c^{a} (16)

For equation 16, a may be a pre-determined number, such as four or five. In some cases, there may be an uptake of residual calcium upon activation. That is, there may be a constant uptake (offset) Δc of Ca on each activation. Ca may refer to calcium or calcium concentration. The impact of uptake on facilitation y may be defined as:

g(y)=(y^{1/a}+Δc)^{a}−y (17)

Furthermore, based on the impact of calcium concentration on facilitation and the uptake of residual calcium upon activation, a linear uptake model may be defined as a piece-wise linear uptake model:

g(y)≅mᵢy+bᵢ (18)

In equation 18, mᵢ and bᵢ are parameters that depend on y. That is, for part with range yᵢ₋₁≦y≦yᵢ, for example, defining mᵢ≅aΔc with bᵢ≅Δc may specify that mᵢ >0.

As previously discussed, in one configuration, when a neuron receives an input from a synapse, a gain of the synapse may increase (e.g., facilitated). Alternatively, in another configuration, the gain of a synapse may decrease (e.g., depressed) when a neuron receives an input from a synapse. Furthermore, the depression or facilitation of the synapse may decay over time so that the changed state may be short-term. In some cases, the network may determine when the synapse will return to a baseline value (ŷ). That is the network may determine the amount of decay over time (ΔT).

Thus, in one configuration, a maintenance signal may be transmitted to the synapse at a time, or before a time, that the synapse returns to the base line value. That is, because the network may determine the amount of decay over time and a time that the synapse will return to a baseline value, the network may transmit a maintenance signal to the synapse prior to or at the time when the synapse returns to the baseline value. The maintenance signal may maintain the state of positive or negative gain of the synapse at a specific level.

Furthermore, in one configuration, the maintenance signal may be transmitted at a specific interval. That is, the network may desire to maintain a specific gain level of a synapse for a period of time. In one configuration, the timing of the maintenance signal matches the decay time. In one example, the gain may decay from a peak gain level to the baseline value in 50 ms. Thus, to maintain a specific gain value for a specific time, such as two seconds, the maintenance signal may be transmitted once every 50 ms, or less, for the desired two-second duration. The specific gain value may be a peak gain value or another gain value that is greater than the baseline value.

In one configuration, the gain of the post-synaptic transmission includes information for a current state value. The post-synaptic transmission may be triggered based on an event, such as a spike. In one configuration, the current state value is equal to the gain of the post-synaptic transmission. In another configuration, the current state value is a function of the gain of the post-synaptic transmission. The current state value is not limited to being equal to or a function of the gain of the post-synaptic transmission. Of course, the current state value may be derived via various formulas based on the gain of the post-synaptic transmission.

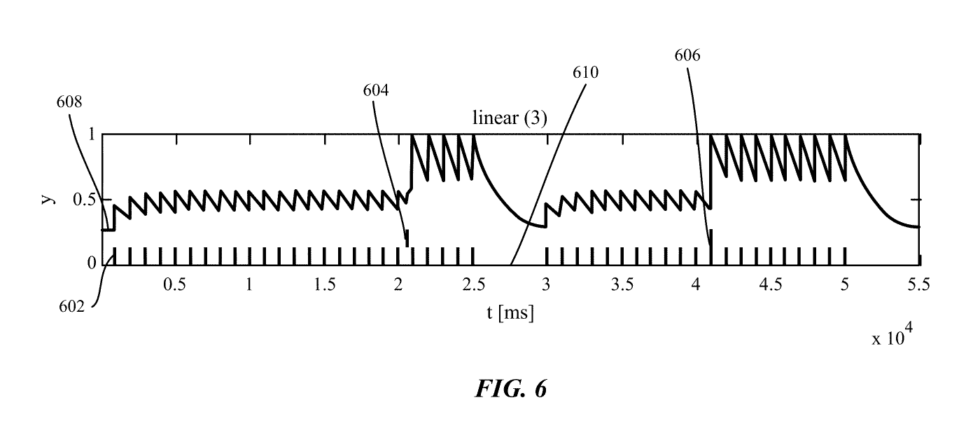

FIG. 6 illustrates a maintenance signal being applied to a synapse according to an aspect of the present disclosure. As shown in FIG. 6, a voltage of a synapse may be at a baseline value at time zero. In FIG. 6, the X-axis represents time and the Y-axis represents voltage values. The voltage values of FIG. 6 are used as an example, aspects of the present disclosure are not limited to the voltages of FIG. 6. Specifically, aspects of the present disclosure are contemplated for an increase or decrease in voltage.

After the initial time of zero, a first maintenance signal 602 may be transmitted to the synapse. In response to receiving the first maintenance signal 602, the voltage 608 may increase to a specific level. After spiking to the specific level, the voltage 608 begins to decay. As shown in FIG. 6, during the decay of the voltage 608 the first maintenance signal 602 is re-transmitted. The retransmission of the first maintenance signal 602 causes the voltage 608 to spike to another level. The first maintenance signal 602 may be transmitted at a specific interval to maintain a level for the voltage 608. As shown in FIG. 6, the voltage decreases between transmissions of the maintenance signal.

Additionally, other maintenance signals may be transmitted to increase the gain of the voltage 608. For example, as shown in FIG. 6, a second maintenance signal 604 may be transmitted at a time that is different from the periodic transmission of the first maintenance signal 602. In this example, in response to both the first maintenance signal 602 and the second maintenance signal 604, the gain of the voltage 608 increases to an amount that is greater than the gain resulting from only the first maintenance signal 602.

Furthermore, as shown in FIG. 6, when a maintenance signal, such as the first maintenance signal 602, is not transmitted for a specific interval 610, the voltage 608 may begin to decay during that interval. Still, as shown in FIG. 6, the gain of the voltage 608 may increase after the specific interval 610 once the periodic transmission of the first maintenance signal 602 resumes. Furthermore, in one configuration, two maintenance signals may be simultaneously transmitted at the same time period. As shown in FIG. 6, at a specific time interval the first maintenance signal 602 and a third maintenance signal 606 may be simultaneously transmitted. The simultaneous transmission of the first maintenance signal 602 and the third maintenance signal 606 may cause the voltage 608 to have a gain increase that is greater than the gain increase that results from only one maintenance signal, such as the first maintenance signal 602.

In some cases, calcium concentration, and thus facilitation, may be limited to some maximum or asymptotic bound due to buffers, calcium gradient and active removal. Moreover, without loss of generality, y has range [ŷ,1] where ŷ is the rest value. That is, the sum of g(y) and y is less than or equal to one. Thus, based on the imposed limit, there is a point y* at which the sum of g(y*) and y* is equal to one. Thereafter for y≦y* the value of g(y) is governed by that limitation. Specifically, g(y) may be governed based on the following:

$${m}_{l} = \frac{- g ( {y}_{*} )}{1 - {y}_{*}} ; \\ {b}_{l} = - {m}_{l} \qquad ( 19 )$$

As an example, a linear three part piece-wise linear uptake model may have an independent property in a middle part flanked by initial and final parts motivated by bounding constraints (typically y₂=y*), and may be defined as:

$$g ( y ) = \{ \begin{matrix}ɛ ( {τ}_{Ø}^{ST} ) ( {y}_{1} - \hat{y} ) & \hat{y} \leq y < {y}_{1} \\ ɛ ( {τ}_{∅}^{ST} ) ( y - \hat{y} ) & {y}_{1} \leq y < {y}_{2} \\ ɛ ( {τ}_{∅}^{ST} ) ( \frac{\hat{y} - {y}_{2}}{{y}_{2} - 1} ) ( y - 1 ) & {y}_{2} \leq y \leq 1\end{matrix} \} \qquad ( 20 )$$

In equation 20,

$$ɛ ( Δ t ) ≡ {e}^{\frac{Δ t}{{τ}_{+}^{ST}}} - 1 ,$$

the Piece-wise Linear Uptake Model may be generalizable to one or more parts.

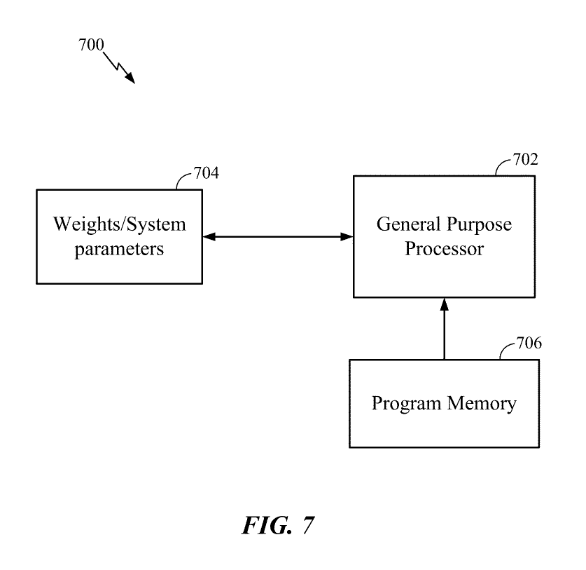

FIG. 7 illustrates an example implementation 700 of the aforementioned modification of a state of a synapse and/or storing state information in a synapse using a general-purpose processor 702 in accordance with certain aspects of the present disclosure. Variables (neural signals), synaptic weights, system parameters associated with a computational network (neural network), delays, and frequency bin information may be stored in a memory block 704, while instructions executed at the general-purpose processor 702 may be loaded from a program memory 706. In an aspect of the present disclosure, the instructions loaded into the general-purpose processor 702 may comprise code for modifying parameters of a synapse so that a strength of a synapse may increase or decrease based on a presynaptic event. In another aspect of the present disclosure, the instructions loaded into the general-purpose processor 702 may comprise code for storing state information in a synapse based at least in part on presynaptic activity and retrieving the state information as postsynaptic activity.

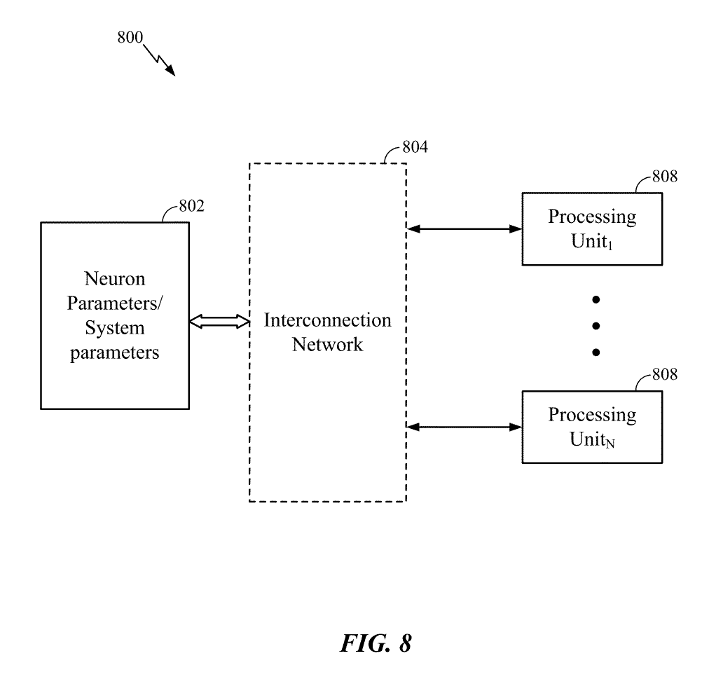

FIG. 8 illustrates an example implementation 800 of the aforementioned modification of a state of a synapse and/or storing state information in a synapse where a memory 802 can be interfaced via an interconnection network 804 with individual (distributed) processing units (neural processors) 808 of a computational network (neural network) in accordance with certain aspects of the present disclosure. Variables (neural signals), synaptic weights, system parameters associated with the computational network (neural network) delays, and/or frequency bin information, may be stored in the memory 802, and may be loaded from the memory 802 via connection(s) of the interconnection network 804 into each processing unit (neural processor) 808. In an aspect of the present disclosure, the processing unit 808 may be configured to modify parameters of a synapse so that a strength of a synapse may increase or decrease based on a presynaptic event. In another aspect of the present disclosure, the processing unit 808 may be configured to store state information in a synapse based at least in part on presynaptic activity and retrieve the state information as postsynaptic activity.

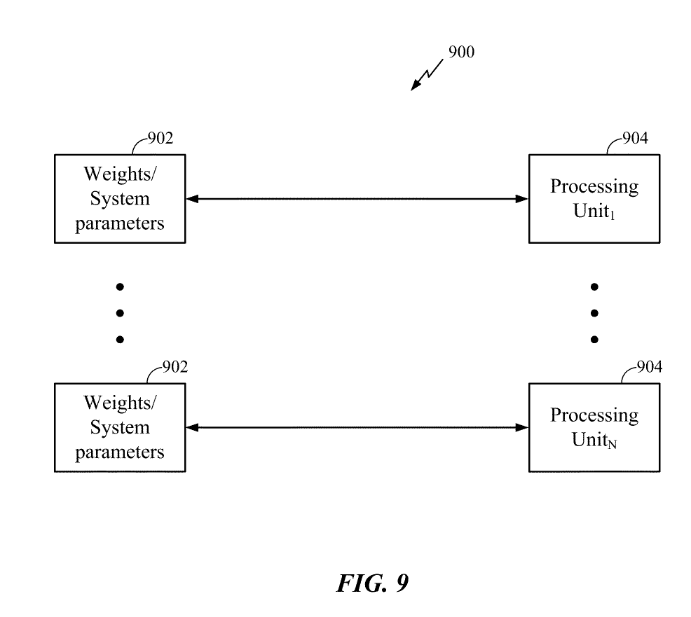

FIG. 9 illustrates an example implementation 900 of the aforementioned modification of a state of a synapse and/or storing state information in synapse. As illustrated in FIG. 9, one memory bank 902 may be directly interfaced with one processing unit 904 of a computational network (neural network). Each memory bank 902 may store variables (neural signals), synaptic weights, and/or system parameters associated with a corresponding processing unit (neural processor) 904 delays, and/or frequency bin information. In an aspect of the present disclosure, the processing unit 904 may be configured to modify parameters of a synapse so that a strength of a synapse may increase or decrease based on a presynaptic event. In another aspect of the present disclosure, the processing unit 904 may be configured to store state information in a synapse based at least in part on presynaptic activity and retrieve the state information as postsynaptic activity.

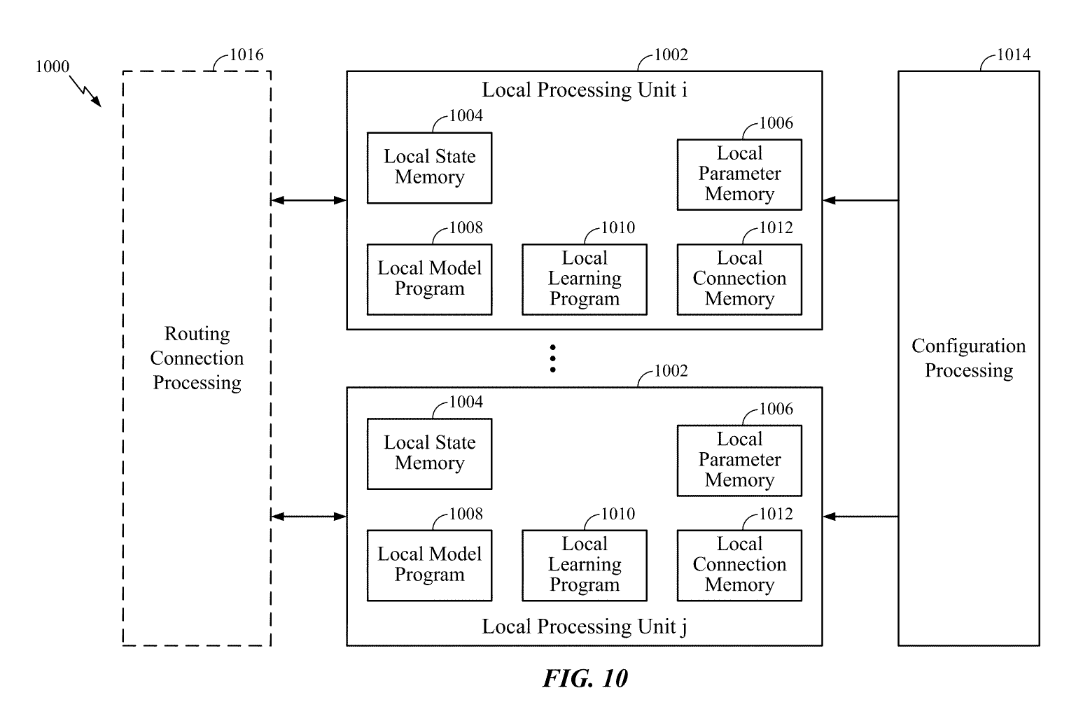

FIG. 10 illustrates an example implementation of a neural network 1000 in accordance with certain aspects of the present disclosure. As illustrated in FIG. 10, the neural network 1000 may have multiple local processing units 1002 that may perform various operations of methods described above. Each local processing unit 1002 may comprise a local state memory 1004 and a local parameter memory 1006 that store parameters of the neural network. In addition, the local processing unit 1002 may have a local (neuron) model program (LMP) memory 1008 for storing a local model program, a local learning program (LLP) memory 1010 for storing a local learning program, and a local connection memory 1012. Furthermore, as illustrated in FIG. 10, each local processing unit 1002 may be interfaced with a configuration processing unit 1014 for providing configurations for local memories of the local processing unit, and with a routing connection processing unit 1016 that provide routing between the local processing units 1002.

In one configuration, a neuron model is configured for modifying parameters of a synapse so that a strength of a synapse may increase or decrease based on a presynaptic activity. The neuron model includes a gain changing means and a gain calculating means. In one aspect, the gain changing mean and/or the gain calculating means may be the general-purpose processor 702, program memory 706, memory block 704, memory 802, interconnection network 804, processing units 808, processing unit 904, local processing units 1002, and or the routing connection processing units 1016 configured to perform the functions recited. In another configuration, the aforementioned means may be any module or any apparatus configured to perform the functions recited by the aforementioned means.

In another configuration, a neuron model is configured to store state information in a synapse based at least in part on presynaptic activity and to retrieve the state information as postsynaptic activity. The neuron model includes a storing means and a retrieving. In one aspect, the storing means and/or retrieving means may be the general-purpose processor 702, program memory 706, memory block 704, memory 802, interconnection network 804, processing units 808, processing unit 904, local processing units 1002, and or the routing connection processing units 1016 configured to perform the functions recited. In another configuration, the aforementioned means may be any module or any apparatus configured to perform the functions recited by the aforementioned means.

According to certain aspects of the present disclosure, each processing unit 808 may be configured to determine parameters of the neural network based upon desired one or more functional features of the neural network, and develop the one or more functional features towards the desired functional features as the determined parameters are further adapted, tuned and updated.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general-purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. In addition, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-Ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for creating and maintaining short term memory using short term plasticity, comprising:
changing a gain of a synapse based at least in part on presynaptic activity without regard to postsynaptic activity.

2. The method of claim 1, in which the gain is based at least in part on a timing of the presynaptic spike activity.

3. The method of claim 2, in which the gain is based at least in part on a function of a time since a most recent presynaptic spike.

4. The method of claim 3, in which the function is characterized as having an exponential decay.

5. The method of claim 3, in which the function is characterized as a non-linear function of an exponential decay to provide a minimum threshold for synaptic transmission.

6. The method of claim 3, in which the function allows the gain to increase and/or decrease.

7. The method of claim 1, further comprising calculating the gain based at least in part on a continuously updated synaptic state variable associated with the short term plasticity.

8. The method of claim 1, in which the synapse includes a gain variable associated with the short term plasticity, the gain variable providing a state for the synapse.

9. The method of claim 1, in which a neuron model includes a gain variable associated with the short term plasticity, the gain variable providing a state for the synapse.

10. A method for creating and maintaining short term memory using short term plasticity, comprising:
storing state information in a synapse based at least in part on presynaptic activity; and
retrieving the state information as postsynaptic activity.

11. The method of claim 10, further comprising adjusting the state information based at least in part on the presynaptic activity.

12. The method of claim 11, in which the presynaptic activity comprises a maintenance signal, and
the method further comprising:
periodically receiving maintenance signals, at the synapse, to maintain a specific gain of the synapse; and
receiving additional maintenance signal, at the synapse, to increase the gain of the synapse.

13. The method of claim 11, in which the presynaptic activity comprises a maintenance signal, and
the method further comprising periodically receiving fewer maintenance signals, at the synapse, to decrease a specific gain of the synapse.

14. The method of claim 10, in which a gain of the postsynaptic activity comprises information corresponding to current state information.

15. An apparatus for creating and maintaining short term memory using short term plasticity, the apparatus comprising:
a memory unit; and
at least one processer coupled to the memory unit; the at least one processor being configured:
to change a gain of a synapse based at least in part on presynaptic spike activity without regard to postsynaptic spike activity.

16. The apparatus of claim 15, in which the gain is based at least in part on a timing of the presynaptic spike activity.

17. The apparatus of claim 16, in which the gain is based at least in part on a function of a time since a most recent presynaptic spike.

18. The apparatus of claim 17, in which the function is characterized as having an exponential decay.

19. The apparatus of claim 17, in which the function is characterized as a non-linear function of an exponential decay to provide a minimum threshold for synaptic transmission.

20. The apparatus of claim 17, in which the function allows the gain to increase and/or decrease.

21. The apparatus of claim 15, in which the at least one processer is further configured to calculate the gain based at least in part on a continuously updated synaptic state variable associated with the short term plasticity.

22. The apparatus of claim 15, in which the synapse includes a gain variable associated with the short term plasticity, the gain variable providing a state for the synapse.

23. The apparatus of claim 15, in which a neuron model includes a gain variable associated with the short term plasticity, the gain variable providing a state for the synapse.

24. An apparatus for creating and maintaining short term memory using short term plasticity, the apparatus comprising:
a memory unit; and
at least one processer coupled to the memory unit; the at least one processor being configured:
to store state information in a synapse based at least in part on presynaptic activity; and
to retrieve the state information as postsynaptic activity.

25. The apparatus of claim 24, in which the at least one processor is further configured to adjust the state information based at least in part on the presynaptic activity.

26. The apparatus of claim 25, in which:
the presynaptic activity comprises a maintenance signal, and
the at least one processor is further configured:
to periodically receive maintenance signals, at the synapse, to maintain a specific gain of the synapse; and
to receive additional maintenance signal, at the synapse, to increase the gain of the synapse.

27. The apparatus of claim 25, in which:
the presynaptic activity comprises a maintenance signal, and
the at least one processor is further configured:
to periodically receive maintenance signals, at the synapse, to maintain a specific gain of the synapse; and
to periodically receive fewer maintenance signals, at the synapse, to decrease a specific gain of the synapse.

28. The apparatus of claim 24, in which a gain of the postsynaptic activity comprises information corresponding to current state information.

29. An apparatus for creating and maintaining short term memory using short term plasticity, comprising:
means for changing a gain of a synapse based at least in part on presynaptic spike activity without regard to postsynaptic spike activity; and
means for calculating the gain based at least in part on a continuously updated synaptic state variable associated with the short term plasticity.

30. An apparatus for creating and maintaining short term memory using short term plasticity, comprising:
means for storing state information in a synapse based at least in part on presynaptic activity; and
means for retrieving the state information as postsynaptic activity.

31. A computer program product for creating and maintaining short term memory using short term plasticity, the computer program product comprising:
a non-transitory computer-readable medium having program code recorded thereon, the program code comprising:
program code to change a gain of a synapse based at least in part on presynaptic spike activity without regard to postsynaptic spike activity.

32. A computer program product for creating and maintaining short term memory using short term plasticity, the computer program product comprising:
a non-transitory computer-readable medium having program code recorded thereon, the program code comprising:
program code to store state information in a synapse based at least in part on presynaptic activity; and
program code to retrieve the state information as postsynaptic activity.
